(19) United States
(12) Patent Application Publication
(10) Pub. No.: US 2019/0385121 A1
(43) Pub. Date: Dec. 19, 2019

(54) TRIP INFERENCES AND MACHINE LEARNING TO OPTIMIZE DELIVERY TIMES

(71) Applicant: Uber Technologies, Inc., San Francisco, CA (US)

(72) Inventors: Ryan Waliany, San Francisco, CA (US); Lei Kang, El Cerrito, CA (US); Ernel Murati, San Francisco, CA (US); Mohammad Shafkat Amin, San Ramon, CA (US); Nikolaus Paul Volk, San Francisco, CA (US); Thanh Le Nguyen, Brisbane, CA (US)

(21) Appl. No.: 16/440,650

(22) Filed: Jun. 13, 2019

Related U.S. Application Data
(60) Provisional application No. 62/685,869, filed on Jun. 15, 2018.

(51) Int. Cl. G06Q 10/08; G06F 9/54

(52) U.S. Cl. CPC G06Q 10/08355; G06F 9/54; G06Q 10/0838; G06Q 10/0833

(57) ABSTRACT

Due to the noisy nature of global positioning systems (GPS), tracing a signal from a device of a delivery provider may be inadequate for the task of determining a best dispatch time. However, leveraging motion data from mobile devices provides a more detailed picture of when a delivery provider is on the road, walking, or waiting. Using this data, an example embodiment creates a trip state model that enables segmenting out each stage of a trip. The trip state model enables collection and use of historical data for individual restaurants, which allows a dispatch system to optimize pickup and delivery times for both delivery providers and consumers.

### REFERENCE TO RELATED APPLICATIONS

This application claims the priority benefit of U.S. Provisional Patent Application No. 62/685,869 filed Jun. 15, 2018 and entitled “Trip Inferences and Machine Learning to Optimize Delivery Times,” which is incorporated herein by reference in its entirety.

### TECHNICAL FIELD

The subject matter disclosed herein generally relates to special-purpose machines configured to optimize delivery times, and to the technologies by which such special-purpose machines become improved compared to other machines that attempt to optimize delivery times. Specifically, the present disclosure addresses systems and methods that uses trip inferences and machine learning to optimize item pickup and delivery times.

### BACKGROUND

Typically, food delivery service is provided based on a guess or estimate. When a user orders food, they may be told a general time to expect the delivery. Similarly, a delivery provider may be told an estimated time to pick up the food. Typically, these time estimates do not take into consideration other factors such as traffic and parking. If the delivery provider is too early for the pickup, the delivery provider waits while the food is being prepared. Conversely, if the delivery provide is late for the pickup, the food may get cold and arrives late to the user.

### BRIEF DESCRIPTION OF THE SEVERAL VIEWS OF THE DRAWINGS

Some embodiments are illustrated by way of example and not limitation in the figures of the accompanying drawings. To easily identify the discussion of any particular element or act, the most significant digit or digits in a reference number refer to the figure number in which that element is first introduced.

FIG. 1 is a diagram illustrating a networked environment suitable for optimizing item pickup and delivery times, in accordance with one embodiment.

FIG. 2 is a diagram illustrating how GPS signals may be interpreted in accordance with one embodiment.

FIG. 3 is a diagrammatic representation of eight activity types defined by the Android activity recognition API in accordance with one embodiment.

FIG. 4 is a diagram illustrating a data flow in a batch pipeline, in accordance with one embodiment.

FIG. 5 is a diagram illustrating a sequence model that detects change-points amongst a series of noisy input observations, in accordance with one embodiment.

FIG. 6 illustrates an example trip state model, in accordance with one embodiment.

FIG. 7 illustrates a flowchart of method for optimizing dispatch and delivery times, in accordance with one embodiment.

FIG. 8 is a block diagram illustrating components of a machine, according to some example embodiments, able to read instructions from a machine-readable medium and perform any one or more of the methodologies discussed herein.

FIG. 9 is a block diagram of a system environment for a networked computer system, in accordance with some example embodiments.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

In a ride-sharing environment, a driver picks up a user from a curbside or other location and drops the user off at their destination, thus completing a trip. Food delivery services face a more complex trip model. When a user or consumer requests a food order using an application (e.g., the Uber Eats App), a specified restaurant begins preparing the order. When the order is ready (or shortly before the order is ready), a service coordination system dispatches a delivery provider (also referred to as a “service provider”) to pick the order up and bring the order to the user (also referred to as a “consumer”).

Modeling the real-world logistics that go into a food delivery trip is a complex problem. With incomplete information, small decisions can make or break the experience for delivery providers and consumers. Example embodiments seek to optimize logic that dispatches a delivery provider to pick up an order. If the dispatch is too early, the delivery provider waits while the food is being prepared. If the dispatch is too late, the food may not be as fresh as it could be, and it arrives late to the consumer. Additionally, example embodiments can provide a better estimate of when the food will be delivered to the consumer.

Due to the noisy nature of GPS, tracing a signal from a device (e.g., mobile phone) of a delivery provider may be inadequate for the task of determining a best dispatch time. However, leveraging motion sensor data from mobile devices provides a more detailed picture of when a delivery provider is driving, walking, or stuck waiting. Using this data, example embodiments create a trip state model, enabling segmentation of each stage of a trip. Furthermore, this model enables collection and use of historical data for individual restaurants, which allows a service coordination system to optimize pickup and delivery times for both a delivery provider and a consumer for a particular restaurant (e.g., pickup location).

The present disclosure provides technical solutions for optimizing item pickup and delivery times. In example embodiments, a network system receives location data (e.g., GPS data) and motion data from a plurality of mobile devices of a plurality of service providers. The location data and motion data are generated on the plurality of mobile devices during respective delivery trips. The network system then generates a trip state model based on the location data and motion data, whereby the trip state model comprises different states corresponding to different activities detected for the plurality of service providers. During runtime, the network system determines a dispatch time to pick up the item and a delivery time for a new delivery trip based on the trip state model. In some cases, the trip state model is specific to each pickup location (e.g., restaurant). The network system then transmits a notification to a device of a further service provider based on the dispatch time, whereby the notification includes a pickup location for the new delivery trip. Because the further service provider arrives at the pickup location when the item (e.g., food) is ready for pickup, the item can be delivered to the service requester as quickly (and efficiently) as possible. As a result, one or more of the methodologies described herein facilitate solving the technical problem of providing automated dispatch of a service provider to a pickup location that optimizes delivery time.

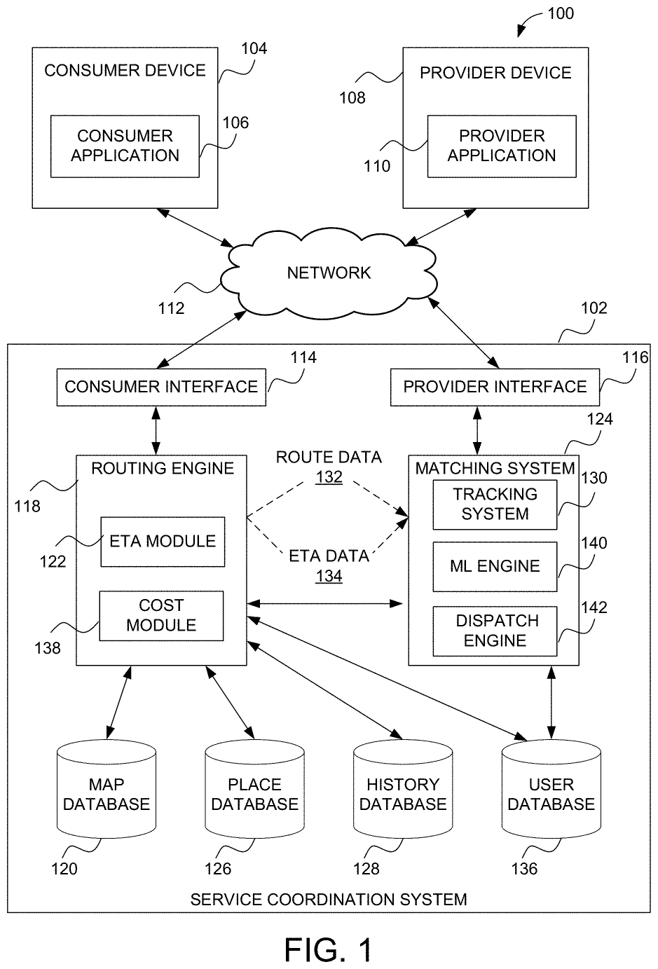

FIG. 1 is a block diagram of a networked environment 100 in which example embodiments may be implemented. A service coordination system 102 is communicatively coupled via a network 112 to both a consumer device 104 and a provider device 108. The consumer device 104 hosts and executes a consumer application 106, while the provider device 108 hosts and executes a provider application 110. In one embodiment, the consumer device 104 is a mobile computing device (e.g., a mobile telephone), executing the consumer application 106 downloaded from an appropriate app store (e.g., the Uber application that executes on either iOS or the Android operating systems). Similarly, the provider device 108 is a mobile computing device, and the provider application is an application designed to run on a mobile operating system (e.g., iOS or Android operating systems). The service coordination system 102 may also interface with other types of devices, such as desktop computers, third-party service systems, and cloud-based computing systems.

The service coordination system 102 includes a consumer interface 114 (e.g., an appropriate set of Application Program Interfaces (APIs)) for facilitating communications, via the network 112, with the consumer device 104. Similarly, a provider interface 116 (e.g., a suitable set of APIs) facilitates communications between the service coordination system 102 and the provider device 108.

In an example embodiment in which the consumer interface 114 and the provider interface 116 comprise APIs, these APIs may also facilitate interactions between the service coordination system 102 and third-party applications hosted on various devices. For example, where the service coordination system 102 is a transportation service system, third-party applications may include widgets or buttons that enable a user to specify and transmit a service request from the third-party application to the transportation service system.

The consumer interface 114 is communicatively coupled, and provides interactive access, to both a routing engine 118 and a matching system 124 of the service coordination system 102. Similarly, the provider interface 116 is communicatively coupled and provides interactive access, to both the routing engine 118 and the matching system 124. At a high level, the routing engine 118 operatively generates route data to facilitate provisioning of services from a service provider to a service consumer. For example, the routing engine 118 generates route data 132 to route a service provider to a location at which an item to be delivered is located. Further, where the service is a transportation service (e.g., of a person or a good), the routing engine 118 generates route data 132 to assist the service provider in delivering the transportation service.

The routing engine 118 further includes an estimated time of arrival (ETA) module 122 that generates ETA data 134. The ETA data 134 relates, for example, to the ETA of a service provider at a location of a service consumer (e.g., a driver at a pick-up location for a passenger or food), the ETA of a consumer at a location of a service provider (e.g., where a consumer travels to a service provider location for delivery of the service), or an ETA for arrival at a destination for a transportation service (e.g., drop off of a passenger or delivery of cargo, food, or item).

In order to generate the route data 132 and the ETA data 134, the routing engine 118, in addition to receiving information from the consumer device 104 and the provider device 108, has access to a map database 120, a place database 126, a history database 128, and a user database 136. The map database 120 contains records for transportation infrastructures (e.g., data reflecting a road network, rail network, or other transportation route network). In one embodiment, the map database 120 includes OpenStreetMap (OSM) data or other proprietary road network data. In one embodiment, the routing engine 118 includes an Open Source Routing Machine (OSRM) engine or any one of several other proprietary routing engines.

The routing engine 118 may also deploy a number of segment cost models (e.g., using cost module 138), algorithms, and data processing techniques in order to generate the route data 132 and the ETA data 134. In one embodiment, the routing engine 118 uses an informed search algorithm, such as A*, to perform low-cost pathfinding and graph traversal by attributing costs of paths or segments between nodes on a graph map (e.g., generated by the cost module 138 with data from the map database 120 and the place database 126). The routing engine 118 may use dynamic contraction hierarchies as part of a routing algorithm. Sharding (e.g., breaking up graphs into geographic regions) may also be used to improve the performance, while the A* or Dijkstra's search algorithm with heuristics, may be used to prioritize nodes in a graph map to generate the route data 132.

The routing engine 118 (e.g., the cost module 138) may also attribute different costs to segments (or adjust the costs of segments), based on various observed (e.g., in near real-time) or known characteristics of an area to be traversed (e.g., the grade or surface condition of a road) and/or a vehicle (e.g., a cycling unit that includes a cyclists, a bicycle, and potentially a cargo). In some example embodiments, the cost of a segment may be adjusted based on a stated intention of a service provider (e.g., a cyclist to ride for a duration or distance during a particular day or other time periods). In yet other embodiments, an expressed or observed affinity/aversion for certain types of segments (e.g., shortcuts or dirt roads) by the service provider may be used to perform adjustments to the costs of segments on demand and in response to a request for routing data.

The map database 120 stores map data according to various formats and standards, such as, for example, the road or route map data roads and transport links formatted as an OSM file. The map data may conform to topological data structures and include multiple types of map data primitives, such as segments, nodes, ways, and relationships. Furthermore, the map database 120 may store Open cyclist Map (OCM) data (this data complying with a map format developed for cyclists and used by OSM). These maps include key information for cyclists, such as national, regional, and local roads, as well as cycle paths and footpaths. Records within the map database 120 may be formatted as OSM files or as shapefiles, which is a format used for storing vector geographic data. Further, the data within the map database 120 may use a topological data structure (e.g., when formatted as an OSM file), with multiple core elements or data primitives. Specifically, these data elements include nodes (e.g., points with a geographic location, stored as latitude and longitude coordinates), ways (e.g., ordered list of nodes representing a polyline or possibly a polygon), relations (e.g., ordered lists of nodes, ways and relations, where each member can have a “role”), and tags (e.g., key-value pairs used to store metadata about map objects). Other examples of map data include HERE TECHNOLOGIES map data (Nokia), TELE ATLAS map data (TomTom), or GOOGLE MAP data.

The place database 126 includes place data in the form of records for various places and locations, whereby these records are used to supplement the map data from the map database 120 when generating the route data 132. Specifically, a place record within the place database 126 includes multiple names or other identifiers for specific locations (e.g., a restaurant or a shop), as well as latitude and longitude information (or other forms of addresses or location information). The place data may be used to more accurately identify a location specified in a request received from either a service consumer or service provider.

The history database 128 stores historical information regarding past trips (e.g., GPS trace routes, trip logs, and reroute incidents). The historical information is used by the routing engine 118, and more specifically the ETA module 122, in order to generate accurate ETA data 134. For example, the historical data within the history database 128 may be used by the ETA module 122 to modify or adjust ETA data 134, based on historical traffic patterns within segments of a particular route. The historical traffic patterns may also take time of day into consideration. In some embodiments, the history database 128 stores the trip state models.

The matching system 124, in one example embodiment, operates as a dispatch system. Specifically, the matching system 124 operatively matches a service request, received from the consumer device 104, with an available service provider. When operating as a dispatch system, the matching system 124 matches a particular service consumer with a particular service provider based on a number of factors, such as a geographic proximity of the respective parties and current or future availability of the relevant service provider. To this end, the matching system 124 accesses a tracking system 130, which receives input from the provider device 108 regarding a current geographic location of a service provider. In some embodiments, the tracking system 130 also receives geographic location information from the consumer device 104 regarding the current location of a consumer. Additionally, the tracking system 130 receives motion and activity data from the provider device 108. The tracking system 130 actively communicates geographic location information regarding the provider device 108 (and in some cases, the consumer device 104) to the ETA module 122, both prior to and during a service delivery operation, to enable the ETA module 122 to dynamically update ETA data 134. The matching system 124 actively communicates updated ETA data 134 to both the consumer device 104 and the provider device 108.

In example embodiments, the tracking system 130 also transmits the location information (e.g., GPS data), motion data, and activity data to a machine learning engine 140. The machine learning engine 140 uses the received information to generate or update trip state models, as will be discussed in more details below.

During runtime, a dispatch engine 142 selects and dispatches a delivery provider to the restaurant at an optimal time based on the trip state model. In some embodiments, the trip state model may be specific to individual restaurants. In these embodiments, the dispatch engine 142 accesses the trip state model for the restaurant from which the consumer is requesting delivery to determine the optimal dispatch and delivery times.

To perform service matching operations, the matching system 124 is communicatively coupled to, and has access to, the user database 136. The user database 136 maintains user records for both service providers and service consumers. The routing engine 118 likewise has access to the user database 136 and uses user profile information maintained within the user database 136 to personalize the route data 132 for either the service consumer or the service provider (e.g., a transportation service provider).

The decisions that logic of the service coordination system 102 makes on when to dispatch delivery providers has a significant impact on a number of trips that each delivery provider can complete, ultimately impacting their earning potential. The GPS signal from devices of delivery providers (e.g., provider device 108) serves as a primary signal to indicate what is happening on a trip. However, GPS data is noisy in urban environments and not sufficient to understand precise interactions between the delivery providers and restaurants. In order to obtain concrete information on the state of a delivery, location data, motion data, and activity data work in tandem, as will be discussed in more detail below.

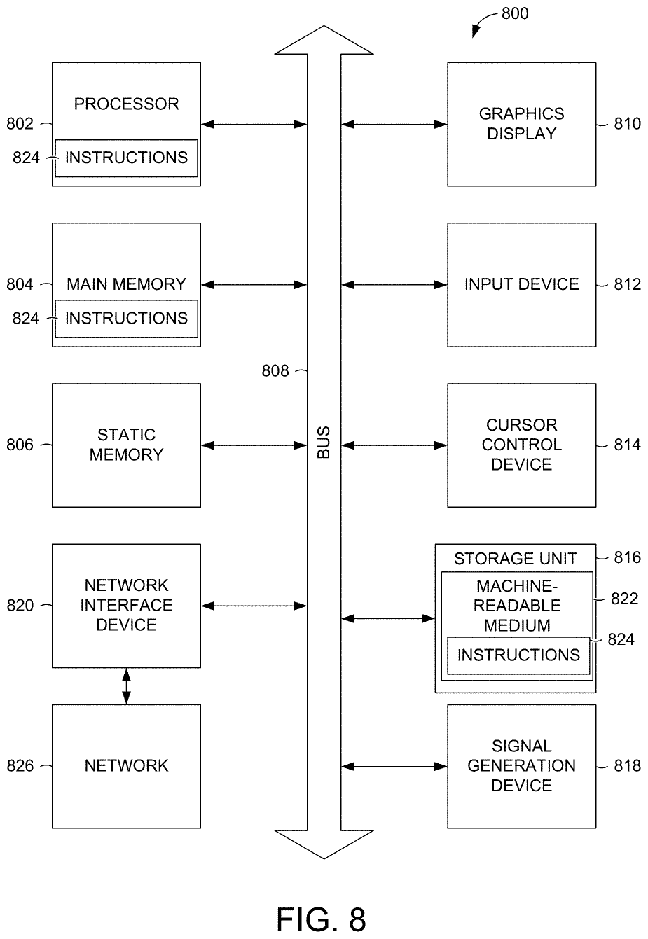

In example embodiments, any of the systems, engines, databases, or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 8, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems, databases, or components (e.g., engines, modules) illustrated in FIG. 1 may be combined into a single system, database, or component, and the functions described herein for any single system, database, or component may be subdivided among multiple systems, databases, or components. Additionally, any number of consumer devices 104 and provider devices 108 may be embodied within the network environment 100. Furthermore, some components or functions of the network environment 100 may be combined or located elsewhere in the network environment 100. For example, some of the functions of the service coordination system 102 may be embodied within other systems or devices of the network environment 100. Additionally, some of the functions of the consumer devices 104 or provider devices 108 may be embodied within the service coordination system 102. While only a single service coordination system 102 is shown, alternative embodiments may contemplate having more than one service coordination system 102 to perform server operations discussed herein for the service coordination system 102.

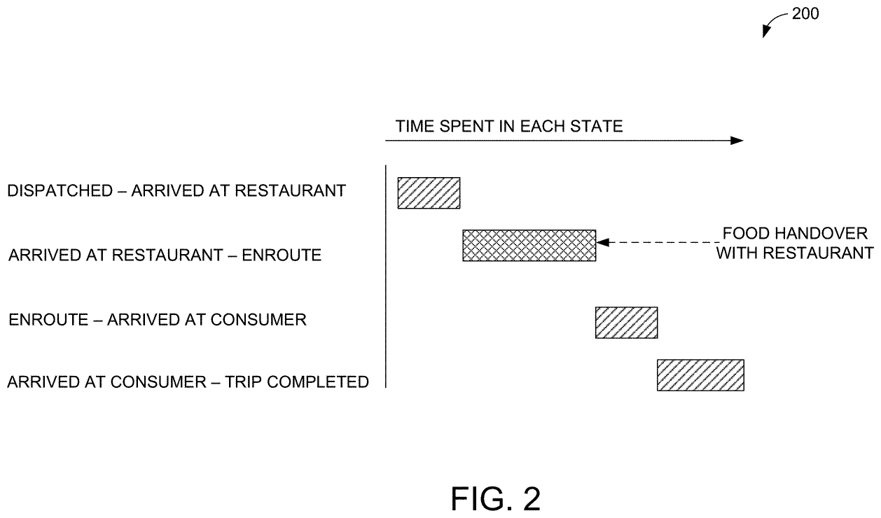

FIG. 2 is a diagram 200 showing how GPS signals and activity data may indicate an activity of a delivery provider (e.g., whether the delivery provider is driving or parked near a pick-up location (e.g., a restaurant) during a trip (e.g., a food delivery trip)). With this approach, as shown in FIG. 2, the service coordination system 102 can determine time spent:

1. Between dispatch and arrival at the restaurant;

2. At the restaurant (e.g., wait time between arrival and enroute to consumer);

3. Enroute to a drop-off location (e.g., consumer location); and

4. Arrival at the drop-off location and completion of the trip.

Additionally, the service coordination system 102 can determine, based on the GPS signals and activity data (and/or motion data), an amount of time spent to arrive at the restaurant, which may include driving to, parking, and walking to the restaurant (e.g., time between dispatch and arrival at a pickup location within the restaurant). In some cases, the driving and parking time may be segmented from the walking time. The service coordination system 102 also determines an amount of time spent waiting for the food (e.g., time between arriving at the restaurant and leaving the restaurant), an amount of time driving to the drop-off location (e.g., time between being enroute and parking at/near the drop-off location), and an amount of time to complete the delivery, which may include walking to the drop-off location (e.g., 3^{rd} floor of an apartment building) and handing over the delivery (e.g., trip completed).

However, it is often unclear from GPS data alone why a delivery provider spends so much time in or around the restaurant before they pick up the consumer's order. Given its noisiness, GPS data is somewhat unreliable. This is often due to a user not having a direct line of sight to active satellites (e.g., due to urban canyons, underground location, in buildings or parking lots). Thus, it is desirable to know if the delivery provider spent this time looking for parking or waiting for the food to be prepared, for example. By using the activity data (and/or motion data) in conjunction with the GPS data, the service coordination system 102 can determine when the delivery provider is looking for parking (e.g., based on speed; vehicle circling the pickup location) and when the delivery provider is walking (e.g., based on motion of the delivery provider crossing a street or through a building or at a “walking pace” that is typically slower than a motion of a vehicle).

One example of a pain point that delivery providers experience is the item (e.g., food) is not ready when the delivery provider arrives at the pick-up location resulting in the delivery provider having to wait. Further still, if the wait is excessive, this prevents the delivery providers from providing services to other consumers.

Example embodiments seek to provide a solution to address the above and other delivery provider pain points. In particular, the service coordination system 102 determines, for example:
Which restaurants have the longest parking times and why?
How long does it typically take for the delivery provider to walk to the restaurant?
Does a restaurant have a difficult pick up process for delivery providers?
When should the dispatch/delivery system 102 dispatch the delivery provider?
Does the delivery provider typically have to wait for the food or is the food waiting for the delivery provider?
Did the delivery provider have trouble with a delivery?

In example embodiments, the service coordination system 102 optimizes delivery time by tracking the above information over time (e.g., looking at historical data) to generate trip state models that provide the above information. In some embodiments, the trip state models may be generated for individual restaurants, which provides even more accurate delivery time estimations. Using the trip state models, the service coordination system 102 determines an optimal time to dispatch a delivery provider to pick up the food to minimize wait time at the restaurant while taking into consideration traffic and parking situations in the area of the restaurant. Additionally, the trip state models allow the service coordination system 102 to determine a more accurate estimate of when the food will arrive at the location of the consumer and provide that information to the consumer.

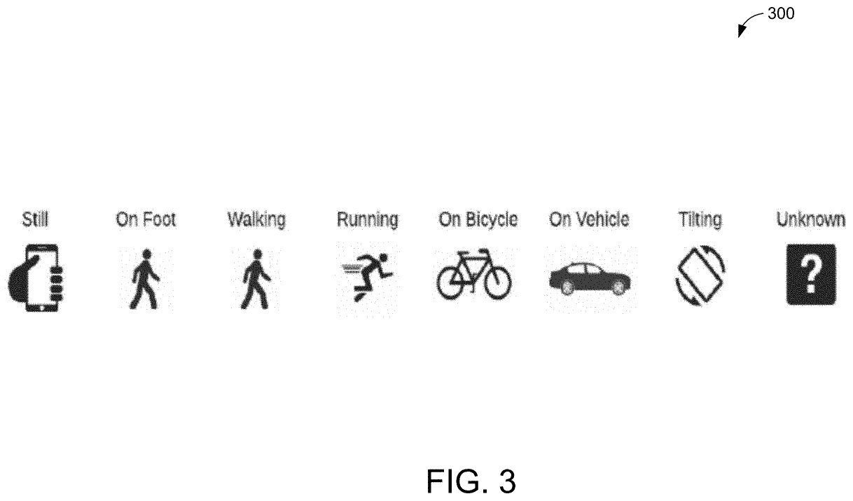

FIG. 3 is a diagrammatic representation of eight activity types 300 defined by an activity recognition application programming interface (API) (e.g., Android activity recognition API). As noted above, GPS data can be extremely noisy and inaccurate, making it insufficient as the only basis for a trip state model. However, the GPS data may be augmented with additional data, namely motion data and activity recognition (AR) data. Motion data comes primarily from accelerometers and gyroscopes in mobile devices (e.g., smartphone). The activity recognition API provides, for example, eight activity labels or types, as shown in FIG. 3. With this sensor landscape in mind, example embodiments can provide a reliable sensor collection and machine learning architecture to feed a trip state model, according to some example embodiments.

In example embodiments, the activity recognition API is built on top of sensors already available in the mobile device. The activity recognition API can automatically detect activity types by periodically reading short bursts of sensor data and processing them using machine learning models. The activity recognition API detects whether a device's sensor value(s) describe the movement of a vehicle (e.g., car, bicycle) or a pedestrian. Thus, the activity recognition API classifies the activity as the user being in/on a vehicle or on foot. Changes in the delivery provider's activities can indicate whether the delivery provider is driving, parking, still/waiting, walking, or on bicycle (which is determined by a component of the service coordination system 102 such as the tracking system 130). In example embodiments, the activity recognition API provides (e.g., transmits to the service coordination system 102) an indication of an activity type or an indication of an activity change when it occurs. The activity predictions can be obtained through a combination of inertial measurement unit motion data and the mobile device's step detection sensors.

In embodiments where the activity recognition API is at the provider device 108 or a system external to the service coordination system 102, the tracking system 130 receives a list of one or more detected activities as well as a confidence score and timestamp for each detected activity. The confidence score indicates a likelihood that the delivery provider is performing the indicated activity. In embodiments where the activity recognition API is a part of the service coordination system 102 (e.g., as part of the tracking system 130), the tracking system 130 receives raw data from the mobile device (e.g., motion data, GPS data) and the activity recognition API processes the raw data to identify the activities.

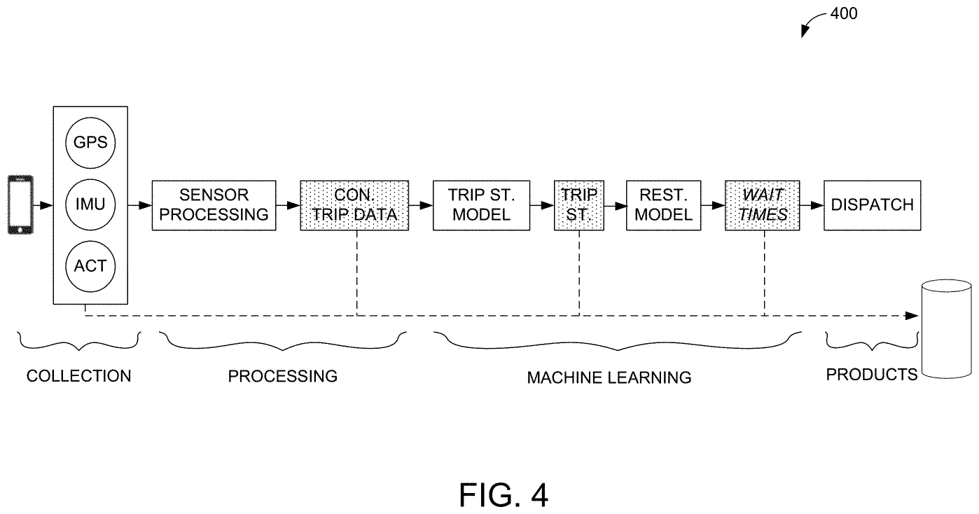

FIG. 4 is a data flow diagram that shows a data flow 400 in a batch pipeline. Initially, data is aggregated on a mobile device (e.g., smartphone). The data includes, in one example embodiment, location information (e.g., GPS data) and motion information (e.g., inertial measurement unit (IMU) data). In some embodiments, an ActivityRecognitionClient API (e.g., on the Android operating system) at the mobile device is used to collect or generate activity recognition data. The data is aggregated into a buffer. The aggregated data is then transmitted or uploaded to the service coordination system 102 for processing (e.g., via separate payloads as part of a network call). In example embodiments, the tracking system 130 receives the aggregated data.

The data is then processed by the tracking system 130 to generate consolidated trip-level data. The service coordination system 102 receives many of these payloads and puts together payloads that belong to a particular trip and user context resulting in the information not being aggregated by payload (as it was at the time of the transportation), but by trip. A single trip may have multiple payloads and at the consolidation level, the service coordination system 102 unites (i.e., consolidates) everything together. In one embodiment, this operation uses simple query joins on trip identifiers and driver identifiers filtered by date.

The consolidated trip-level data is then used to generate a trip state model by the machine learning engine 140. In example embodiments, the trip state model is a sequential model capable of inferring a sequence of discrete states from a sequence of noisy observations. These inferred discrete states are temporally related (e.g., the system can impose order in the states and only a finite set of state transitions are possible). For example, a delivery provider can wait at a restaurant only after parking their vehicle. Additionally, a current state plays an important role in modeling the inferred states. For instance, if the delivery provider is currently walking, they will very likely keep walking in a next timestamp. Example embodiments use conditional random field (CRF), a discriminative, undirected probabilistic graphical model, to approximate such functions. In some cases, enhanced conditional random fields with kernels are used to capture non-linear relationships in the data. Modeling the problem as a CRF allows the flexibility to integrate signals from multiple sources, including activities from the mobile device (e.g., provider device 108) and proximity to restaurants. Alternative embodiments can use Hidden Markov models and recurrent neural networks. To feed consolidated trip-level data into the trip state model, a dataset of labeled data as follows may be assembled:
(restaurant1, driver1, timestamp1, parked)
(restaurant1, driver1, timestamp2, waiting_at_restaurant)
(restaurant1, driver1, timestamp3, walking_to_car)
(restaurant1, driver1, timestamp4, enroute_to_eater)

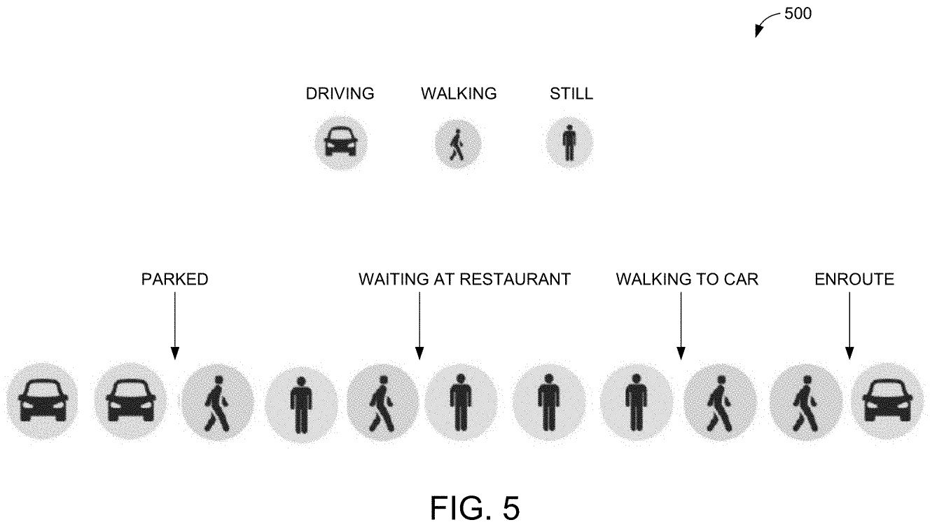

As shown in FIG. 5, sequence models are capable of finding delivery provider change-points amongst a sequence of state observations. These observations comprise activities or activities fused with other modalities, such as GPS and motion sensors. Finding these change points is challenging because of noisy observations. In particular, even though, for example, Android-based activities report their confidences (e.g., confidence scores), the Android-based classifier is noisy and separation boundaries between change points may not be very clean (e.g., as shown in FIG. 5 by a still activity between the two walking activities after parking the vehicle).

Additionally, change-points can be difficult to identify because of a lack in ground truth data. In order to train high-performing sequence models, sufficient ground truth data from restaurants is needed. However, restaurants show very different delivery provider patterns and behaviors. There is also difficulties in obtaining this generally sparse data for each restaurant in a scalable fashion.

In an example embodiment, a trip state model is a sequential model capable of inferring a sequence of discrete states from a sequence of noisy observations. These inferred discrete states are temporally related (e.g., order can be imposed in the states and only a finite set of state transitions are possible). For example, a delivery provider can wait at the restaurant only after they have parked the vehicle in the parking lot and walked to the restaurant. Additionally, the current state plays an important role in modeling the inferred states. For example, if the delivery provider is currently walking, they will very likely keep walking in a next timestamp.

A conditional random field (CRF) (as an example of a discriminative, undirected probabilistic graphical model) may be used to approximate such functions. Conditional random fields are enhanced with kernels to capture non-linear relationships in the data. Modeling the problem as a CRF allows flexibility to integrate signals from multiple sources, including activities from the provider device 108 and proximity to restaurants. Other viable approaches are Hidden Markov models and recurrent neural networks.

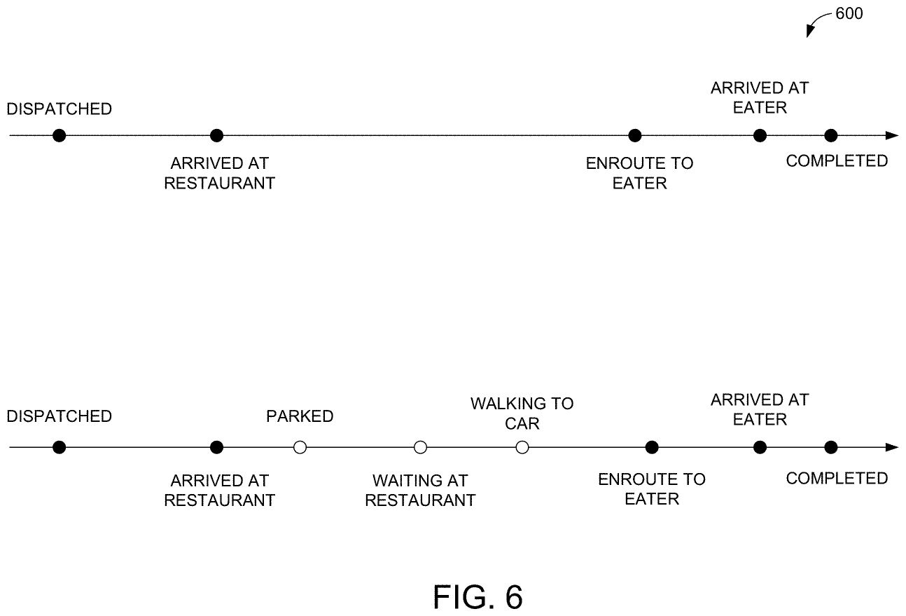

FIG. 6 is a diagram showing an example trip state model 600. Aggregating GPS data and using sensor data (e.g., from Android phones) enables creation of a detailed trip state model. This model provides an in-depth look at how a food delivery trip proceeds and gives an opportunity to fine-tune parameters that are controllable by the service coordination system 102, such as dispatch time, to ensure the best experience for not only delivery providers but also restaurant-partners and eaters/consumers. FIG. 6 shows additional detail achieved in the trip state model 600.

By aggregating time series sensor data (e.g., by the machine learning engine 140), the trip state model 600 infers the likelihood that the delivery provider is in one of the following states for each point in time (e.g., trip inferences):
Arrived at restaurant: the delivery provider has arrived at the restaurant and may be circling the block to find a parking spot. The total duration of this state can be used to adjust dispatch or power preferential dispatch (e.g., dispatching bikes (e.g., bicycle or motorbike) to restaurants with long parking times).
Parked: the delivery provider has parked and is now walking and locating the pick-up spot at the restaurant. During this state, the GPS location of the phone can help ensure accuracy of location data for the restaurant.
Waiting at restaurant: the delivery provider has found the designated pick-up spot and is waiting for the food to be prepared. Analyzing the duration of this state helps improve dispatch algorithms and estimated time of delivery (ETD).
Walking to car: the delivery provider has picked up the food and is heading back to their vehicle.
Enroute to eater/comsumer: the delivery provider is back in their vehicle, enroute to delivering the food to the eater.

Arrival at the restaurant and enroute to the consumer/eater are easier to detect due to the movement of the vehicle and GPS data. However, parked (and walking to restaurant), waiting at restaurant, and walking to car may be harder to detect as motion data (e.g., velocity and orientation) is limited or small. Therefore, inferences for some of these states may not be as accurate (and is shown with open circles in FIG. 6). The trip state model 600 provides an understanding of what is happening in the real world, enables optimization of dispatch to improve food freshness, and works with restaurants to reduce delivery provider waiting time and parking time. Overall, a move from heuristics to models allows the service coordination system 102 to greatly improve operational efficiency.

Inference steps use machine learning (ML) models aimed at improving the product experience for the delivery provider and consumer by accurately calculating dispatch and delivery times. Referring back to FIG. 4, using the trip state model, a trip state, a restaurant model, and wait times can be determined by the machine learning engine 140. The restaurant model refers to historical configurations of a particular restaurant. In the restaurant model, data such as location, peak demand time, parking wait time and other features are considered to make predictions about the current state of the order. For example, if the system knows that on Monday 2 PM, parking wait time for a particular restaurant is on average 20 minutes, this information is considered when making a prediction of the parking time for a next Monday 2 PM.

Based on the trip states, restaurant model, and wait times, the dispatch engine 142, during runtime and in response to a service request, determines a delivery provider for a delivery and dispatches the delivery provider (e.g., sends a notification to the provider device 108 of the delivery provider to pick up the food for delivery) at an appropriate dispatch time. In example embodiments, a distribution inferred from the trip state model—depicting an average time spent in the waiting, walking, and parking states for a particular restaurant is used to determine dispatch. When dispatching a delivery provider to the restaurant, the service coordination system 102 uses the detailed historic breakdown of trip states (e.g., waiting, walking, and parking states) to ensure the delivery provider arrives just when the food is ready. This dispatch method minimizes the wait time for the delivery provider at the restaurant and, ultimately, helps the delivery provider complete more trips. For the consumer, the service coordination system 102 may offer better ETDs and ensure that the food is delivered as soon as possible after it is prepared—resulting in a fresher meal and shorter wait time.

Additionally, the service coordination system 102 learns more about the parking time for each restaurant, which also allows for improvement of dispatch efficiency. The service coordination system 102 optimizes pick-ups based on time of day, traffic, and the restaurant. At the scale of a large service coordination system, these improvements can have a very profound impact on improving the delivery provider trip experience.

The data (e.g., received, generated, and inferred) in the process flow 400 are stored to a database (e.g., history database 128) for future analysis. For example, the data can be updated with future trip data to refine the trip state model.

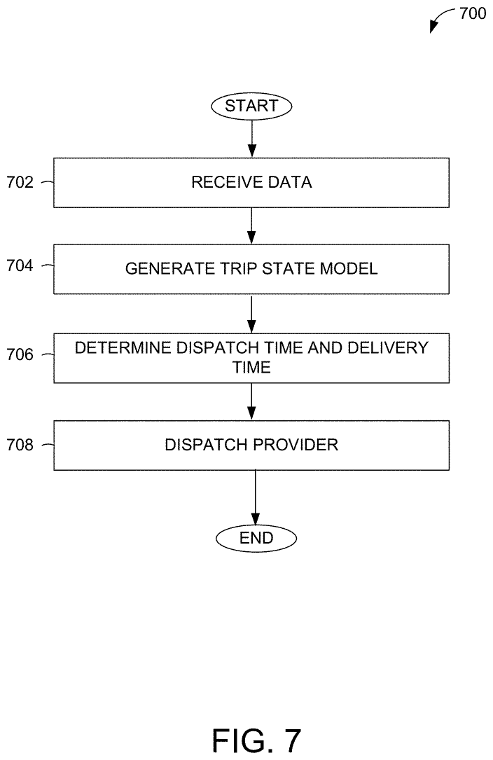

FIG. 7 is a flowchart of a method 700 for optimizing dispatch and delivery times. Operations in the method 700 are performed by the service coordination system 102, using components described above with respect to FIG. 1. Accordingly, the method 700 is described by way of example with reference to the service coordination system 102. However, it shall be appreciated that at least some of the operations of the method 700 may be deployed on various other hardware configurations or be performed by similar components residing elsewhere in the network environment 100. Therefore, the method 700 is not intended to be limited to the service coordination system 102.

In operation 702, the service coordination system 102 receives data from a plurality of mobile devices of delivery service providers (e.g., provider device 108). The data includes location data (e.g., GPS data) and motion data (e.g., inertia measurement unit data), for example, detected by accelerometers and gyroscopes of the plurality of mobile devices. In some embodiments, the service coordination system 102 receives activity data (e.g., activity type data and confidence scores from an activity recognition API). In other embodiments, the service coordination system 102 determines the activity data from the GPS and motion data.

In operation 704, the service coordination system 102 generates a trip state model based on the received data. The trip state model comprises segmentation of different stages for each specific delivery trip (e.g., divides up the delivery trip into different segments based on a corresponding activity). An example of a trip state model is shown in FIG. 6 and is generated as discussed with respect to FIG. 4.

In operation 706, the service coordination system 102, during runtime and in response to a service request, uses the trip state model to determine a dispatch time and an estimated delivery time. In example embodiments, when the service coordination system 102 receives a service request (e.g., food delivery request), the service coordination system 102 accesses the trip state model, and in some cases, the restaurant model and uses the models to determine an average or typical amount of time it takes for the restaurant to prepare the food as well as driving time (e.g., traffic) and parking time for the restaurant. In some cases, the models and determined times are based on time of day (e.g., longer driving time during rush hour) or day of week (e.g., less traffic on weekends). Based on these determined times, the service coordination system 102 determines an optimal time to dispatch a service provider to the restaurant for pickup.

Additionally, the service coordination system 102 determines an estimated delivery time based on when the food is predicted to be ready for pickup as well as traffic patterns between the restaurant and the delivery location (e.g., location of the consumer). In some embodiments, the service coordination system 102 determines a route between the restaurant and the delivery location. Based on the route, an ETD (or ETA) can be determined that factors in traffic for a specific time of day (e.g., may be long ETD if delivery is during rush hour).

In operation 708, a provider is dispatched at the appropriate time based on the dispatch time determined in operation 706. Accordingly, the service coordination system 102 transmits a notification to the provider device 108 at the dispatch time. In some embodiments, the service coordination system 102 selects a service provider based on their current location (e.g., from GPS data) and estimated time to reach the pickup location in the restaurant (e.g., including driving, parking, and walking time) such that the service provider arrives at the pickup location within the restaurant when the food is ready. In these embodiments, the dispatch time corresponds to the estimated time to reach the pickup location.

FIG. 8 illustrates components of a machine 800, according to some example embodiments, that is able to read instructions from a machine-readable medium (e.g., a machine-readable storage device, a non-transitory machine-readable storage medium, a computer-readable storage medium, or any suitable combination thereof) and perform any one or more of the methodologies discussed herein. Specifically, FIG. 8 shows a diagrammatic representation of the machine 800 in the example form of a computer device (e.g., a computer) and within which instructions 824 (e.g., software, a program, an application, an applet, an app, or other executable code) for causing the machine 800 to perform any one or more of the methodologies discussed herein may be executed, in whole or in part.

For example, the instructions 824 may cause the machine 800 to execute the flow diagrams of FIGS. 4 and 7. In one embodiment, the instructions 824 can transform the general, non-programmed machine 800 into a particular machine (e.g., specially configured machine) programmed to carry out the described and illustrated functions in the manner described.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824 (sequentially or otherwise) that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a graphics display 810 (e.g., a plasma display panel (PDP), a light emitting diode (LED) display, a liquid crystal display (LCD), a projector, or a cathode ray tube (CRT), or any other display capable of displaying graphics or video). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a sound card, an amplifier, a speaker, a headphone jack, or any suitable combination thereof), and a network interface device 820.

The storage unit 816 includes a machine-readable medium 822 (e.g., a tangible machine-readable storage medium) on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered as machine-readable media (e.g., tangible and non-transitory machine-readable media). The instructions 824 may be transmitted or received over a network 826 via the network interface device 820.

In some example embodiments, the machine 800 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 804, 806, and/or memory of the processor(s) 802) and/or storage unit 816 may store one or more sets of instructions and data structures (e.g., software) 824 embodying or utilized by any one or more of the methodologies or functions described herein. These instructions, when executed by processor(s) 802 cause various operations to implement the disclosed embodiments.

As used herein, the terms “machine-storage medium,” “device-storage medium,” “computer-storage medium” (referred to collectively as “machine-storage medium 822”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 822 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 822 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 824 may further be transmitted or received over a communications network 826 using a transmission medium via the network interface device 820 and utilizing any one of a number of well-known transfer protocols (e.g., HTTP). Examples of communication networks 826 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

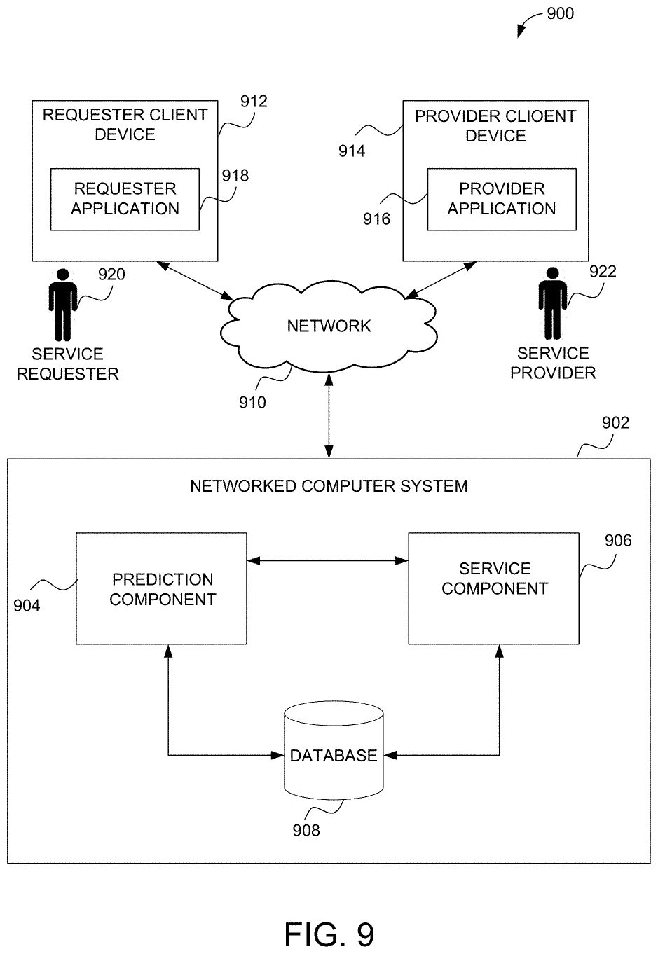

FIG. 9 is a block diagram of a further system environment 900 for a networked computer system 902, in accordance with some example embodiments. In some example embodiments, the networked computer system 902 coordinates the transportation of persons and/or goods/items for a service requester 920 (e.g., such as a rider or consumer) by a service provider or delivery provider 922 (e.g., a driver of a vehicle). The service provider 922 uses a vehicle (e.g., a bicycle. motorbike, car or truck) to provide transportation (e.g., passenger or goods) to the service requester 920.

In some example embodiments, the networked computer system 902 comprises any combination of one or more of a prediction component 904, a service component 906, and a database 908. These components 904 and 906 and database 908 are not native components of a generic computer system and provide structures and functions beyond generic function of a computer system, as further described below.

In some example embodiments, the prediction component 904, the service component 906, and the database 908 reside on a machine having a memory and at least one processor (not shown). In some example embodiments, the components reside on the same machine, while in other example embodiments, one or more of these components reside on separate remote machines that communicate with each other via a network (e.g., network 910). It is contemplated that other configurations are also within the scope of the present disclosure.

In some example embodiments, the service requester 920 operates a requester client device 912 that executes a requester application 918 that communicates with the networked computer system 902. The service requester 920 operates the requester application 918 to view information about the networked computer system 902, and to make a request for service from the networked computer system 902 for a delivery or transport service (“a trip”) of the service requester 920 and, optionally, additional persons) and/or items, for example cargo needing transport. The requester application 918 determines a pick-up location within an origin location or enables the service requester 920 to specify a pick-up location and/or a destination location associated with the trip. An origin location and/or a destination location may be a location inputted by the service requester 920 or may correspond to the current location of the requester client device 912 as determined automatically by a location determination component (not shown) in the requester client device 912 (e.g., a global positioning system (GPS) component, a wireless networking system, or a combination thereof). For purposes of simplicity, as described herein, an origin location can include a pick-up location for service (i) determined by the requester application 918 (e.g., based on the current location of the requester client device 912 using a GPS component), (ii) specified or selected by the service requester 920, or (iii) determined by the networked computer system 902. In some embodiments, the networked computer system 902 recommends a pick-up location to the service requester 920 based on historical trip data associated with the origin location.

According to examples herein, the requester client device 912 transmits a set of data to the networked computer system 902 over the network 910 in response to requester input or operation of the requester application 918. Such data can be indicative of the requester's interest in potentially requesting service (e.g., before actually confirming or requesting the service). For example, the service requester 920 may launch the requester application 918 and specify an origin location and/or a destination location to view information from the networked computer system 902 before making a decision on whether to request service. The service requester 920 may want to view information about the average or estimated time of arrival for pick up by the service provider 922, the estimated time to the destination, the price, the available service types, and so forth. Depending on the implementation, the data can include the origin and/or destination location information, requester information (e.g., identifier), application information (e.g., version number), device identifier or type, etc. According to some examples, each time the service requester 920 modifies the origin and/or destination location, the requester application 918 generates and transmits the data to the networked computer system 902.

The network 910 is any network that enables communication between or among machines, databases, and devices (e.g., the networked computer system 902, the requester client device 912 and the provider client device 914). Accordingly, the network 910 may be a wired network, a wireless network (e.g., a mobile or cellular network), or any suitable combination thereof. The network 910 may include one or more portions that constitute a private network, a public network (e.g., the Internet), or any suitable combination thereof. Accordingly, the network 910 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 910 may communicate information via a transmission medium. As used herein, “transmission medium” shall be taken to include any intangible medium that is capable of storing, encoding, or carrying instructions for execution by a machine, and includes digital or analog communication signals or other intangible media to facilitate communication of such software.

Once the service requester 920 confirms or orders a service via the requester application 918, the requester application 918 generates data corresponding to a request for the service through the networked computer system 902 (e.g., also referred to herein as a “trip request”). Responsive to receiving a trip request, the networked computer system 902 determines the average estimated time of arrival (ETA) at the pick-up location of each service provider 922 whose current location is within a threshold distance of the pick-up location (e.g., each service provider 922 within one mile of the pickup location). In some embodiments, responsive to determining that requester's ETA is within a threshold amount of time of the average ETA of each nearby available service provider 922, the networked computer system 902 uses information from the trip request to match the service requester 920 with an available service provider 922. Depending on implementation, the trip request can include requester or device information (e.g., a requester identifier, a device identifier), a service type (e.g., vehicle type) and/or selected service option (such as described herein), an origin location, a destination location, a payment profile identifier, a desired departure time, and/or other data. The networked computer system 902 selects a service provider 922 from a set of providers, such as based on the provider's current location and status (e.g., offline, online, available) and/or information from the trip request (e.g., service type, origin location, and/or destination location), to provide the service for the service requester 920 and transport the service requester 620 from the origin location to the destination location. Responsive to selecting an available service provider 922, the networked computer system 902 sends an invitation message to the provider client device 914 inviting the service provider 922 to fulfill the trip request.

In embodiments where the service request is for delivery of food, the networked computer system 902 determines a time that the food should be ready for pick up and the average estimated time of arrival (ETA) at the pick-up location for each service provider 922 whose current location is within a threshold distance of the pick-up location (e.g., each service provider 922 within one mile of the pickup location). In some embodiments, the networked computer system 902 uses information from the service request (e.g., delivery request) to select an available service provider 922 that can be dispatched and arrive at the restaurant approximately at a time when the food is ready for pick up. The networked computer system 902 selects the service provider 922 from a set of providers, such as, based on the provider's current location and status (e.g., offline, online, available) and/or information from the service request (e.g., origin location and/or destination location), to provide the service for the service requester 920 and transport the item (e.g., food) from the origin location (e.g., a restaurant) to the destination location (e.g., location of the service requester 920). Responsive to selecting an available service provider 922, the networked computer system 902 sends an invitation message to the provider client device 914 inviting the service provider 922 to fulfill the delivery request.

In one example embodiment, the networked computer system 902 periodically determines the service provider's ETA at the pick-up location based on the topological and geospatial location of the service provider client device 914. In some example embodiments, the networked computer system 902 selects the service provider 922 based on a comparison of the service provider's ETA and an estimated time when the food will be ready at the pick-up location. For example, if the networked computer system 902 determines that the food will be ready in about five minutes, the networked computer system 902 may select the service provider 922 who is also about five minutes away even if other service providers are closer.

The service provider 922 operates a provider client device 914 executing a provider application 916 that communicates with the networked computer system 902 to provide information indicating whether the service provider 922 is available or unavailable to provide transportation or delivery services to a specific service provider 922. The provider application 916 can also present information about the networked computer system 902 to the service provider 922, such as invitations to provide service, navigation instructions, map data, and so forth. In one example embodiment, the provider application 916 enables the service provider 922 to provide information regarding the availability of the service provider 922 by logging into the networked computer system 902 and activating a setting indicating that they are currently available to provide service. The provider application 916 also provides the current location of the service provider 922 or the provider requester client device 914 to the networked computer system 902. Depending on implementation, the current location may be a location inputted by the service provider 922 or may correspond to the current location of the provider requester client device 914 as determined automatically by a location determination component (not shown) in the provider client device 914 (e.g., a GPS component, a wireless networking system, or a combination thereof). The provider application 916 further allows the service provider 922 to receive, from the networked computer system 902, an invitation message to provide a service for the service requester 920, and if the service provider 922 accepts via input, the provider application 916 transmits an acceptance message to the networked computer system 902. The networked computer system 902 subsequently provides information about the service and/or service provider 922 to the requester application 918. In another example embodiment, the provider application 916 can enable the service provider 922 to view a list of current trip or service requests and to select a particular trip or service request to fulfill. The provider application 916 can also receive routing information from the networked computer system 902.

In some example embodiments, the requester client device 912 and provider client device 914 are portable or mobile electronic devices such as smartphones, tablet devices, wearable computing devices (e.g., smartwatches) or similar devices. Alternatively, the provider client device 914 can correspond to an onboard computing system of a vehicle. Client devices typically have one or more processors, memory, touch screen displays, wireless networking system (e.g., IEEE 802.11), cellular telephony support (e.g., LTE/GSM/UMTS/CDMA/HSDP A), and location determination capabilities. The requester client device 912 and the provider client device 914 interact with the networked computer system 902 through client applications configured to interact with the networked computer system 902. The requester application 918 and the provider application 916 of the requester client device 912 and the provider client device 914, respectively, can present information received from the networked computer system 902 on a requester interface, such as a map of the geographic region, and the current location of the requester client device 912 or the provider client device 914. The applications running on the requester client device 912 and the provider client device 914 can determine the current location of the device and provide the current location to the networked computer system 902.

The networked computer system 902 is configured to provide a communicative interface between the requester application 918, the provider application 916, and the various components and databases in the networked computer system 902. The networked computer system 902 is configured to receive provider availability status information and current location information from the provider application 916 and update the database 908 with the availability status. The networked computer system 902 is also configured to receive trip or service requests from the requester application 918 and create corresponding trip records in the database 908. According to an example embodiment, a trip record corresponding to a trip or service request can include or be associated with a trip ID, a requester ID, an origin location, a destination location, a service type, pricing information, and/or a status indicating that the corresponding trip request has (or has not) been processed. According to one example embodiment, when the service provider 922 accepts the invitation message to service the trip or service request for the service requester 920, the trip record is updated with the provider's information as well as the provider's location and the time when the trip or service request was accepted. Similarly, location and time information about the service as well as the cost for the service can be associated with the trip record.

In one example embodiment, during the trip, the networked computer system 902 receives information (e.g., periodically) from the provider application 916 indicating the location of the provider's vehicle and/or telematics information (e.g., indications of current speed, acceleration/deceleration, events, stops, and so forth). The networked computer system 902 stores the information in the database 908 and can associate the information with the trip record. In some example embodiments, the networked computer system 902 periodically calculates the provider's ETA to the drop-off location (e.g., delivery location of the service requester 920) and provides the provider's ETA to the requester application 918.

The networked computer system 902 determines the geospatial and topological location of the requester client device 912 in response to the service requester 920 making a trip request through the requester application 918. In one example embodiment, the requester application 918 periodically transmits geospatial location information of the requester provider client device 912 to the networked computer system 902. The geospatial location information can correspond to a current location data point of the requester client device 912 at an instance in time. Such a location data point can be generated by a location determination component (not shown) in the requester provider client device 912 (e.g., a GPS component, a wireless networking system, or a combination thereof).

In some example embodiments, the requester application 918 and the provider application 916 are configured to display map data indicating a specific geographical location of a place, as well as navigation instructions for the service requester 920 using the requester application 918 on how to navigate (e.g., walk) to the specific geographical location of the place and navigation instructions for the service provider 922 using the provider application 916 on how to navigate (e.g., drive) to the specific geographical location of the place. For example, the provider application 916 may display, on the requester client device 914 of the service provider 922, a map that includes a graphic element that corresponds to the current location of the service provider 922 or the provider client device 914 of the service provider 922 and a graphic element that corresponds to the specific geographical location of a place associated with a service request, such as a place to pick up or drop off the service requester 920 associated with the service request, as well as a route from the current location of the service provider 922 or the provider client device 914 of the service provider 922 to the specific geographical location of the place associated with the service request. Similarly, the requester application 918 may display, on the provider client device 912 of the service requester 920, a map that includes a graphic element that corresponds to the current location of the service requester 920 or the requester client device 912 of the service requester 920 and a graphic element that corresponds to the specific geographical location of the place associated with the service request, as well as a route from the current location of the service requester 920 or the requester client device 912 of the service requester 920 to the specific geographical location of the place associated with the service request.

The map data and the navigation instructions are generated based on the specific geographical location of the place associated with the service request. In some example embodiments, the corresponding map data and navigation instructions are generated by the requester application 918 and the provider application 916 using the geographical location of the place, which is received by the requester application 918 and the provider application 916 from the networked computer system 902. For example, the networked computer system 902 stores the geographical location of the place in association with an identifier of the place (e.g., a name of the place, an address of the place) in the database 908, and then transmits the geographical location of the place to the requester application 918 and the provider application 916 for use in generating the corresponding map data and navigation instructions that are to be generated and displayed by the requester application 918 and the provider application 916. In other example embodiments, the corresponding map data and navigation instructions are generated by the networked computer system 902 using the geographical location of the place stored in the database 908 of the networked computer system 902 in association with an identifier of the place (e.g., a name of the place, an address of the place), and then transmitted to the requester application 918 and the provider application 916 for display on requester client device 912 of the service requester 920 and the provider client device 914 of the service provider 922.

In some example embodiments, the geographical location of a place comprises a geocode. A geocode comprises a spatial representation in numerical coordinates, such as latitude and longitude, of a physical location (e.g., a physical address). Other types of representations of a physical location may additionally or alternatively be used as the geographical location in providing the features disclosed herein.

In some example embodiments, the prediction component 904 is configured to, for a place, access corresponding service data for each one of a plurality of requests for a transportation service associated with the place. The service data may be stored in and retrieved from the database(s). The transportation service may comprise transportation to the place or transportation from the place. In some example embodiments, the transportation service comprises transportation of the service requester 920 of the request. However, it is contemplated that the transportation service may additionally or alternatively comprise transportation of another user, such as a friend, relative, or other acquaintance of the service requester 920 of the request (e.g., when the requester submits a request for transportation service for a friend). Accordingly, although examples disclosed herein refer to the requester client device 912 of the service requester 920 of the request, the client device of another user (not shown) may be substituted for the requester client device 912 of the service requester 920 for embodiments in which the other user is the one who is being transported. Additionally, the provider client device 914 of the service provider 922 may also be substituted for the requester client device 912 of the service requester 920 for embodiments in which the transportation service is for transportation of a good rather than for transportation of a person, such as in embodiments in which the transportation service is being used for delivery of food or other products.

In some example embodiments, the corresponding service data for each one of the requests comprises an identification of the place (e.g., a name or an address), pick-up data indicating a pick-up location where the transportation of the requester began (e.g., a name, an address, or a geocode), and drop-off data indicating a drop-off location where the transportation of the requester ended (e.g., a name, an address, or a geocode).

In some example embodiments, the prediction component 904 is configured to access corresponding sensor data for each one of the plurality of requests. The corresponding sensor data may indicate at least one path of the provider client device 912 of the service requester 920. In some example embodiments, the path(s) comprise at least one of a pick-up path and a drop-off path. The pick-up path ends at the pick-up location indicated by the pick-up data, and the drop-off path begins at the drop-off location indicated by the drop-off data.

Efficient data processing encompasses scalability, architecture robustness, and reliability, as well as modeling and machine learning challenges. The approaches discussed herein represents a move from heuristics to models.

### EXAMPLES

Example 1 is a method for optimizing dispatch and delivery time. The method comprises receiving, at a network system, location and motion data from a plurality of mobile devices of a plurality of service providers, the location and motion data having been generated on the plurality of mobile devices during respective delivery trips; generating, using one or more hardware processors of the network system, a trip state model based on the location and motion data, the trip state model comprising different states corresponding to different activities detected for the plurality of service providers; using the trip state model, determining a dispatch time and a delivery time for a new delivery trip; and transmitting, by the network system, a notification to a device of a further service provider based on the dispatch time, the notification including a pickup location for the new delivery trip.

In example 2, the subject matter of example 1 can optionally include wherein the trip state model is specific to the pickup location.

In example 3, the subject matter of examples 1-2 can optionally include wherein the receiving of the location and motion data further comprises receiving activity data from an activity recognition API, the activity data including an activity type and a confidence score.

In example 4, the subject matter of examples 1-3 can optionally include selecting the service provider based on a current location of the further service provider based and estimated time to reach the pickup location, the estimated time to reach the pickup location corresponding to the dispatch time.

In example 5, the subject matter of examples 1-4 can optionally include transmitting the delivery time determined based on the trip state model to a service requester, the delivery time comprising an estimate of when a delivery item will arrive at a location of the service requester.

In example 6, the subject matter of examples 1-5 can optionally include selecting the service provider based on the trip state model, the selecting comprising selecting a bike service provider based on the pickup location having a long parking time.

In example 7, the subject matter of examples 1-6 can optionally include wherein the trip state model includes one or more of the following states: a dispatched state indicating that a service provider of the plurality of service providers has been dispatched for item pickup; an arrived state indicating that the service provider has arrived at a pick-up location in a delivery vehicle; a parked state indicating that the service provider is parked proximate to the pick-up location; a wait state indicating that the service provider is waiting at the pick-up location; a walking state indicating that the service provider is walking from the pick-up location to the delivery vehicle; an enroute state indicating that the service provider is enroute from the pick-up location to a delivery location; or a completed state indicating a delivery trip is completed.

Example 8 is a system for optimizing dispatch and delivery time. The system includes one or more processors and a memory storing instructions that, when executed by the one or more hardware processors, causes the one or more hardware processors to perform operations comprising receiving location and motion data from a plurality of mobile devices of a plurality of service providers, the location and motion data having been generated on the plurality of mobile devices during respective delivery trips; generating a trip state model based on the location and motion data, the trip state model comprising different states corresponding to different activities detected for the plurality of service providers; using the trip state model, determining a dispatch time and a delivery time for a new delivery trip; and transmitting a notification to a device of a further service provider based on the dispatch time, the notification including a pickup location for the new delivery trip.

In example 9, the subject matter of example 8 can optionally include wherein the trip state model is specific to the pickup location.

In example 10, the subject matter of examples 8-9 can optionally include wherein the receiving of the location and motion data further comprises receiving activity data from an activity recognition API, the activity data including an activity type and a confidence score.

In example 11, the subject matter of examples 8-10 can optionally include wherein the operations further comprise selecting the service provider based on a current location of the further service provider based and estimated time to reach the pickup location, the estimated time to reach the pickup location corresponding to the dispatch time.

In example 12, the subject matter of examples 8-11 can optionally include wherein the operations further comprise transmitting the delivery time determined based on the trip state model to a service requester, the delivery time comprising an estimate of when a delivery item will arrive at a location of the service requester.

In example 13, the subject matter of examples 8-12 can optionally include wherein the operations further comprise selecting the service provider based on the trip state model, the selecting comprising selecting a bike service provider based on the pickup location having a long parking time.

In example 14, the subject matter of examples 8-13 can optionally include wherein the trip state model includes one or more of the following states a dispatched state indicating that a service provider of the plurality of service providers has been dispatched for item pickup; an arrived state indicating that the service provider has arrived at a pick-up location in a delivery vehicle; a parked state indicating that the service provider is parked proximate to the pick-up location; a wait state indicating that the service provider is waiting at the pick-up location; a walking state indicating that the service provider is walking from the pick-up location to the delivery vehicle; an enroute state indicating that the service provider is enroute from the pick-up location to a delivery location; or a completed state indicating a delivery trip is completed.

Example 15 is a machine-storage medium for optimizing dispatch and delivery time. The machine-storage medium configures one or more processors to perform operations comprising receiving location and motion data from a plurality of mobile devices of a plurality of service providers, the location and motion data having been generated on the plurality of mobile devices during respective delivery trips; generating a trip state model based on the location and motion data, the trip state model comprising different states corresponding to different activities detected for the plurality of service providers; using the trip state model, determining a dispatch time and a delivery time for a new delivery trip; and transmitting a notification to a device of a further service provider based on the dispatch time, the notification including a pickup location for the new delivery trip.

In example 16, the subject matter of example 15 can optionally include wherein the trip state model is specific to the pickup location.

In example 17, the subject matter of examples 15-16 can optionally include wherein the receiving of the location and motion data further comprises receiving activity data from an activity recognition API, the activity data including an activity type and a confidence score.

In example 18, the subject matter of examples 15-17 can optionally include wherein the operations further comprise selecting the service provider based on a current location of the further service provider based and estimated time to reach the pickup location, the estimated time to reach the pickup location corresponding to the dispatch time.

In example 19, the subject matter of examples 15-17 can optionally include wherein the operations further comprise transmitting the delivery time determined based on the trip state model to a service requester, the delivery time comprising an estimate of when a delivery item will arrive at a location of the service requester.

In example 20, the subject matter of examples 15-17 can optionally include wherein the operations further comprise selecting the service provider based on the trip state model, the selecting comprising selecting a bike service provider based on the pickup location having a long parking time.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving, at a network system, location and motion data from a plurality of mobile devices of a plurality of service providers, the location and motion data having been generated on the plurality of mobile devices during respective delivery trips;
generating, using one or more hardware processors of the network system, a trip state model based on the location and motion data, the trip state model comprising different states corresponding to different activities detected for the plurality of service providers;
using the trip state model, determining, by the network system, a dispatch time and a delivery time for a new delivery trip; and
transmitting, by the network system, a notification to a device of a further service provider based on the dispatch time, the notification including a pickup location for the new delivery trip.

2. The method of claim 1, wherein the trip state model is specific to the pickup location.

3. The method of claim 1, wherein the receiving of the location and motion data further comprises receiving activity data from an activity recognition API, the activity data including an activity type and a confidence score.

4. The method of claim 1, further comprising:
selecting the service provider based on a current location of the further service provider based and estimated time to reach the pickup location, the estimated time to reach the pickup location corresponding to the dispatch time.

5. The method of claim 1, further comprising:
transmitting the delivery time determined based on the trip state model to a service requester, the delivery time comprising an estimate of when a delivery item will arrive at a location of the service requester.

6. The method of claim 1, further comprising:
selecting the service provider based on the trip state model, the selecting comprising selecting a bike service provider based on the pickup location having a long parking time.

7. The method of claim 1, wherein the trip state model includes one or more of the following states:
a dispatched state indicating that a service provider of the plurality of service providers has been dispatched for item pickup;
an arrived state indicating that the service provider has arrived at a pick-up location in a delivery vehicle;
a parked state indicating that the service provider is parked proximate to the pick-up location;
a wait state indicating that the service provider is waiting at the pick-up location;
a walking state indicating that the service provider is walking from the pick-up location to the delivery vehicle;
an enroute state indicating that the service provider is enroute from the pick-up location to a delivery location; or
a completed state indicating a delivery trip is completed.

8. A system comprising:
one or more hardware processors; and
a memory storing instructions that, when executed by the processor, causing the one or more hardware processors to perform operations comprising:
receiving location and motion data from a plurality of mobile devices of a plurality of service providers, the location and motion data having been generated on the plurality of mobile devices during respective delivery trips;
generating a trip state model based on the location and motion data, the trip state model comprising different states corresponding to different activities detected for the plurality of service providers;
using the trip state model, determining a dispatch time and a delivery time for a new delivery trip; and
transmitting a notification to a device of a further service provider based on the dispatch time, the notification including a pickup location for the new delivery trip.

9. The system of claim 8, wherein the trip state model is specific to the pickup location.

10. The system of claim 8, wherein the receiving of the location and motion data further comprises receiving activity data from an activity recognition API, the activity data including an activity type and a confidence score.

11. The system of claim 8, wherein the operations further comprise:
selecting the service provider based on a current location of the further service provider based and estimated time to reach the pickup location, the estimated time to reach the pickup location corresponding to the dispatch time.

12. The system of claim 8, wherein the operations further comprise:
transmitting the delivery time determined based on the trip state model to a service requester, the delivery time comprising an estimate of when a delivery item will arrive at a location of the service requester.

13. The system of claim 8, wherein the operations further comprise:
selecting the service provider based on the trip state model, the selecting comprising selecting a bike service provider based on the pickup location having a long parking time.

14. The system of claim 8, wherein the trip state model includes one or more of the following states:
a dispatched state indicating that a service provider of the plurality of service providers has been dispatched for item pickup;
an arrived state indicating that the service provider has arrived at a pick-up location in a delivery vehicle;
a parked state indicating that the service provider is parked proximate to the pick-up location;
a wait state indicating that the service provider is waiting at the pick-up location;
a walking state indicating that the service provider is walking from the pick-up location to the delivery vehicle;
an enroute state indicating that the service provider is enroute from the pick-up location to a delivery location; or
a completed state indicating a delivery trip is completed.

15. A computer-readable storage medium storing instructions that, when executed by one or more hardware processors of a machine, cause the machine to perform operations comprising:
receiving location and motion data from a plurality of mobile devices of a plurality of service providers, the location and motion data having been generated on the plurality of mobile devices during respective delivery trips;
generating a trip state model based on the location and motion data, the trip state model comprising different states corresponding to different activities detected for the plurality of service providers;
using the trip state model, determining a dispatch time and a delivery time for a new delivery trip; and
transmitting a notification to a device of a further service provider based on the dispatch time, the notification including a pickup location for the new delivery trip.

16. The computer-readable storage medium of claim 15, wherein the trip state model is specific to the pickup location.

17. The computer-readable storage medium of claim 15, wherein the receiving of the location and motion data further comprises receiving activity data from an activity recognition API, the activity data including an activity type and a confidence score.

18. The computer-readable storage medium of claim 15, wherein the operations further comprise:
selecting the service provider based on a current location of the further service provider based and estimated time to reach the pickup location, the estimated time to reach the pickup location corresponding to the dispatch time.

19. The computer-readable storage medium of claim 15, wherein the operations further comprise:
transmitting the delivery time determined based on the trip state model to a service requester, the delivery time comprising an estimate of when a delivery item will arrive at a location of the service requester.

20. The computer-readable storage medium of claim 15, wherein the operations further comprise:
selecting the service provider based on the trip state model, the selecting comprising selecting a bike service provider based on the pickup location having a long parking time.
